(19) United States
(12) Patent Application Publication
(10) Pub. No.: US 2005/0134749 A1
(43) Pub. Date: Jun. 23, 2005

(54) Reflection resistant display

(76) Inventor: Adiel Abileah, Portland, OR (US)

Correspondence Address: Kevin L. Russell, Suite 1600, 601 SW Second Ave., Portland, OR, 97204-3157, US

(21) Appl. No.: 10/741,912

(22) Filed: Dec. 19, 2003

(51) Int. Cl. G02F 1/1335

(52) U.S. Cl. 349/16; 349/12

(57) ABSTRACT

A reflection resistant display with a protective layer together with a polarizer. A light valve for selective presenting an image. A gap between the light valve and the protective layer.

### BACKGROUND OF THE INVENTION

The present invention relates to a display and, more particularly, to a reflection resistant display with a protective layer.

In some cases it is desirable to include an additional vandal glass plate to the front of the display to protect against it being damaged, such as for automated teller applications. To include additional security the glass plate is spaced apart from the front of the display by a gap, such as an air gap. Typically, the vandal glass is either glass, or otherwise a glass plate sandwiching material there between to reduce the tendency of the glass to shatter upon impact.

Generally, an LCD comprises a light valve that controls the intensity of light passing through the panel from a source at the back of the LCD (a “backlight”) to a viewer's eyes at the front of the panel. The light valve generally comprises a pair of polarizers separated by layer of liquid crystals filling a cell gap between the polarizers. The optical axes of the two polarizers are arranged relative to each other so that light from the backlight is either blocked or transmitted through the polarizers. The liquid crystals are birefringent and translucent and the relative orientation of the crystals of the layer can be controlled to switch the light valve from a transmitting state where light is transmitted through the two polarizers to a non-transmitting state where light transmission is blocked. For example, the walls of the cell gap may be buffed to create microscopic grooves that orient adjacent molecules of liquid crystal with optical axes of the two polarizers. Liquid crystals exhibit a dipole that attracts neighboring crystals and causing the crystals of columns spanning the liquid crystal layer to align with each other. If the crystals at the limits of the layer are arranged at an angle to each other to align with the optical axis of the polarizers, the crystals of the intervening column will be progressively twisted into alignment by the dipole. The plane of vibration of light transmitted from the first polarizer passing through a column of crystals is also “twisted” so that it is aligned with the optical axis of the second polarizer and visible to the viewer (in a “normally white” LCD). To turn a pixel off and create an image, a voltage is applied to an electrode of an array of electrodes on the walls of the cell gap with reference to a common electrode causing adjacent liquid crystals to be twisted out of alignment with the optical axis of the adjacent polarizer attenuating the light transmitted from the backlight to the viewer. (Conversely, the polarizers of the light valve of a “normally black” LCD are arranged so that the pixel is “off” or “black” when the controlling electrode is not energized and switched “on” or “white” when the electrode is energized.)

While LCDs are the displays of choice for many applications, the combination of an LCD display device and a vandal glass type plate can be problematic. The principal problem is that displays are reflective and, when exposed to intense ambient lighting, the luminance of the reflection often overpowers the image being displayed by the LCD.

The reflectivity of a display is principally the result of the facing surfaces of the vandal glass, air gap, and front of the display. Glass has a relatively high index of refraction while the air in the gap between the surfaces has an index of refraction of 1.0. The percentage of perpendicularly incident light reflected from a discontinuity in the index of refraction is, approximately: R(%)=((n₂−n₁)/(n₂+n₁))/2.

where:

n₂=index of refraction for the optically denser material
n₁=index of refraction for the optically less dense material
R=percentage of incident light reflected
   (It is noted that the aforementioned equation is only accurate for perpendicular viewing directions.) The result of two transitions of the glass-to-air and air-to-polarizer boundaries by ambient light from the front of the panel is sufficient to obscure the displayed image under modest to high intensity ambient lighting conditions.

What is desired, therefore, is a screen providing substantially reduced reflection of ambient light and an undistorted image.

### BRIEF DESCRIPTION OF THE DRAWINGS

FIG. 1 is an exploded cross-section of a touch screen comprising a vandal glass panel and an associated liquid crystal display (LCD).

FIG. 2 is an exploded cross-section of a touch screen comprising a vandal glass panel of alternative construction and an associated liquid crystal display (LCD).

FIG. 3 is a schematic representation of a polarizer.

### DETAILED DESCRIPTION OF THE INVENTION

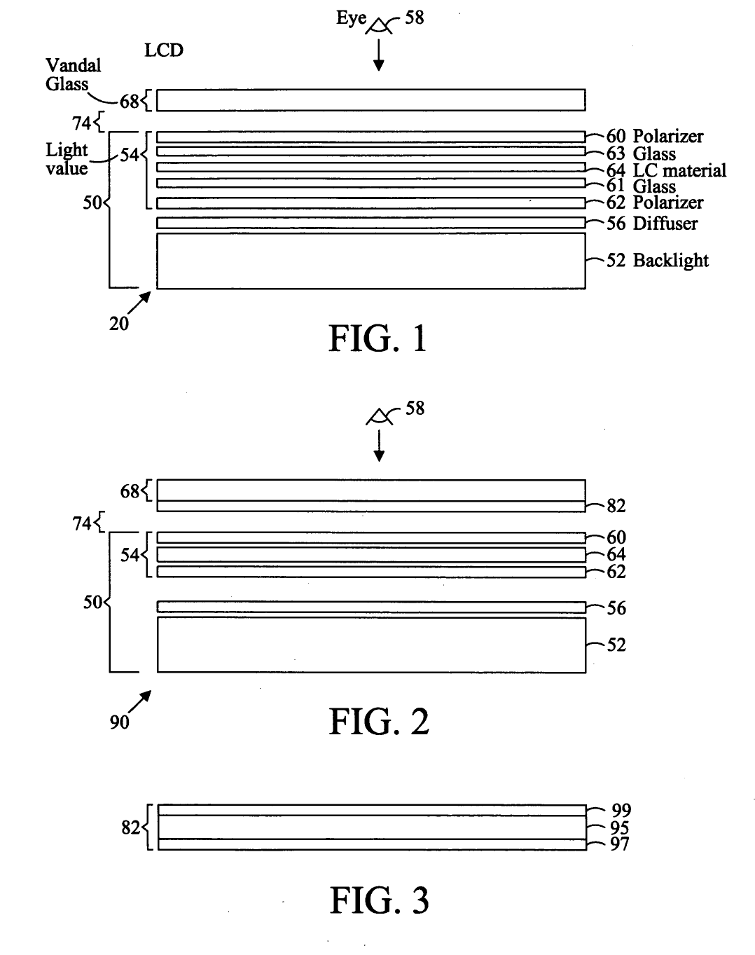

Referring to FIGS. 1 and 2 (like elements are identified by common item numbers), a vandal glass display generally comprises a transparent vandal glass or other transparent material 68 (indicated by a bracket) which is installed proximate to the display screen of a computer operated display, such as a liquid crystal display (LCD) 50 or a cathode ray tube (CRT) monitor. Typically, vandal glass displays are produced as separate units and are often supplied by different manufacturers.

A liquid crystal display (LCD) 50 (indicated by a bracket) comprises generally, a backlight 52 and a light valve 54 (indicated by a bracket). Since liquid crystals do not emit light, most LCD panels are backlit with flourescent tubes or arrays of light-emitting diodes (LEDs) that are built into the sides or back of the panel. To disperse the light and obtain a more uniform intensity over the surface of the display, light from the backlight 52 typically passes through a diffuser 56 before impinging on the light valve 54.

The transmittance of light from the backlight 52 to the eye of a viewer 58, observing an image displayed on the front of the panel, is controlled by the light valve 54. The light valve 54 comprises a pair of polarizers 60 and 62 separated by a layer of liquid crystals 64 contained in a cell gap between the polarizers. Light from the backlight 52 impinging on the first polarizer 62 comprises electromagnetic waves vibrating in a plurality of planes. Only that portion of the light vibrating in the plane of the optical axis of a polarizer can pass through the polarizer. In an LCD light valve, the optical axes of the first 62 and second 60 polarizers are typically arranged at an angle so that light passing through the first polarizer would normally be blocked from passing through the second polarizer in the series. However, the orientation of the translucent crystals in the layer of liquid crystals 64 can be locally controlled to either “twist” the vibratory plane of the light into alignment with the optical axes of the polarizers, permitting light to pass through the light valve creating a bright picture element or pixel, or out of alignment with the optical axis of one of the polarizers, attenuating the light and creating a darker area of the screen or pixel.

The surfaces of a first glass plate 63 and a second glass plate 61 form the walls of the cell gap and are buffed to produce microscopic grooves to physically align the molecules of liquid crystal 64 immediately adjacent to the walls. Molecular forces cause adjacent liquid crystal molecules to attempt to align with their neighbors with the result that the orientation of the molecules in the column of molecules spanning the cell gap twist over the length of the column. Likewise, the plane of vibration of light transiting the column of molecules will be “twisted” from the optical axis of the first polarizer 62 to a plane determined by the orientation of the liquid crystals at the opposite wall of the cell gap. If the wall of the cell gap is buffed to align adjacent crystals with the optical axis of the second polarizer, light from the backlight 52 can pass through the series of polarizers 60 and 62 to produce a lighted area of the display when viewed from the front of the panel (a “normally white” LCD).

To darken a pixel and create an image, a voltage, typically controlled by a thin film transistor, is applied to an electrode in an array of transparent electrodes deposited on the walls of the cell gap. The liquid crystal molecules adjacent to the electrode are attracted by the field produced by the voltage and rotate to align with the field. As the molecules of liquid crystal are rotated by the electric field, the column of crystals is “untwisted,” and the optical axes of the crystals adjacent to the cell wall are rotated progressively out of alignment with the optical axis of the corresponding polarizer progressively reducing the local transmittance of the light valve 54 and attenuating the luminance of the corresponding pixel. Conversely, the polarizers and buffing of the light valve can be arranged to produce a “normally black” LCD having pixels that are dark (light is blocked) when the electrodes are not energized and light when the electrodes are energized. Color LCD displays are created by varying the intensity of transmitted light for each of a plurality of primary color (typically, red, green, and blue) sub-pixels that make up a displayed pixel.

The aforementioned example was described with respect to a twisted nematic device. However, this description is only an example and other devices may likewise be used, including, but not limited to, multi-domain vertical alignment (MVA), patterned vertical alignment (PVA), in-plane switching (IPS), and super-twisted nematic (STN) type LCDs.

Several vandal glass technologies are available. A simple glass plate is typically the least expensive and, therefore, the most common. Referring to FIG. 1, a vandal glass 68 (indicated by a bracket) comprises generally a substantially rigid, transparent glass substrate 70 spaced apart by an air gap 74 that is maintained by a plurality of transparent insulators that are deployed between the substrate and the display. The proximate surfaces 78 and 80 of the substrate 70 and the LCD 50, respectively, are glass and a polarizer.

Vandal glass LCD-based screens are highly desirable for many applications because an LCD is lighter, more rugged, more energy efficient, and more compact than a CRT. However, a vandal glass panel is very reflective and in modest to high intensity ambient lighting the luminance of the reflection from the panel may be sufficient to obscure the image displayed by an LCD.

The readability of an LCD is a function of the luminance (brightness) and contrast of the LCD display and the luminance of the reflected ambient light. While the brightness of the LCD can be increased by increasing the intensity of the backlight, the contrast between light and dark areas of the screen is limited by the ability of the light valve to extinguish light from the backlight to produce darkened pixels. The contrast of the screen is typically specified by the ratio of the contrast of light and dark pixels: CR=L_{W}/L_{B}

where:

CR=contrast ratio
L_{W}=luminance of white state (lighted pixel)
L_{B}=luminance of black state (darkened pixel)

The contrast ratio is typically specified for a display viewed in a darkened room because of the effect of reflected ambient light on the contrast ratio at a defined viewing angle. For example, an LCD with a white state luminance of 200 nits and a black state luminance of 0.5 nits has a contrast ratio of 400 when viewed in a darkened room. On the other hand, if the LCD is viewed in a well-lit room that produces a glare of 20 nits at the front surface, the white state luminance will be 220 nits, the black state luminance will be 20.5 nits, and the contrast ratio will be 10.7 (220/20.5) substantially less than the contrast ratio for the display in the darkened room. Since the extinction ratio of the light valve and, therefore, the contrast ratio of the LCD in a darkened room are essentially fixed, increasing the brightness of the backlight to overcome the effects of ambient light reflections produces limited improvements in the readability of the display. Reducing the reflection of ambient light from a panel without significantly reducing the brightness or the contrast ratio of the displayed image can significantly improve the readability of LCD displays used in environments with higher intensity ambient lighting.

Ambient light impinging on the front of a screen passes through the transparent layers of the panel and the LCD. Light is reflected when it crosses the boundary between two materials that have differing indices of refraction. For example, the high reflectivity of the panel is principally the result of the interaction of ambient light on the proximate surfaces 78 and o0 of the LCD 50 and the glass 68. Glass has a high index of refraction while the air in the gap between the surfaces has an index of refraction of 1.0. As a result of transiting the glass-to-air interface, a substantial portion of the ambient light impinging on the front of the panel is reflected back to the viewer 58.

Referring to FIG. 2, a polarizer 82 arranged on the vandal glass 68 of the display can significantly reduce the reflection of ambient light. The ambient light randomly vibrates in all planes, but only that portion of the light vibrating in the plane of a polarizer can pass through the polarizer. As a result, a polarizer 82 in front of the touch screen substantially reduces the light reaching the interfaces for reflection back to the viewer 58. If the optical axis of the polarizer 82 on the front of the screen is aligned with the optical axis of the second polarizer 60 of the light valve 54 transmission of the image from the light valve is maximized. However, adding a polarizer 82 to the vandal glass distorts the image in some cases. The present inventor concluded that the image distortion is primarily the result of the interaction of the polarized light comprising the image with birefringent materials interposed between the light valve and the polarizer 82. For example, the support for the polarizer may be manufactured from polyester (PET) which is birefringent as a result of its molecular structure. In addition, the birefringence of a material is altered by the effects of local strain on the molecular structure. When the glass of a panel is deformed by contact, stress causes the birefringence of the cover to vary spatially. As a result, the polarizer 82 interferes to varying degrees with the polarized light comprising the image and the image is distorted. The present inventor concluded that reflection of ambient light could be reduced by arranging a polarizer on the glass panel and that the image quality could be preserved by avoiding introducing birefringence in the optical path between the light valve 54 and the polarizing material of the polarizer 82.

The supporting material for the polarizer 82 toward the LCD 50 comprises a substantially non-birefringent, flexible material, such as polycarbonate (PC), triacetate cellulose (TAC), or polyvinyl alcohol (PVA). Since the supporting material for the polarizer 82 is substantially non-birefringent, the polarization of light transiting the glass is unaffected by the material and distortion of the image as a result of interference between the optical axes of the polarizer 82 and stressed areas of the deformed polarizer is avoided. The birefringence has a retardation, preferably, less than 25; more preferably, less than 15; and yet more preferably, less than 5.

Referring to FIG. 3, the polarizer 82 comprises a polarizing element 95 supported by and bonded to a first surface of a flexible, non-glass, support layer 97. The support layer 97 comprises a non-birefringent material such as PVA that is bonded to the birefringent polarizing element 95 to form a polarizer 94 that can be the polarizer 82. The polarizer 82 may also include another layer 99 which is either substantially non-birefringent or birefringent.

The panel and the surfaces 78 and 80 may have a glare diffusing front surfaces. Glare is the result of reflection of light at an exposed surface. The reflection from an untreated polished surface is generally specular as in a reflection from a mirror. Typically, antiglare treatments roughen or coat the surface to create a texture that scatters the incident light and cause the reflection to be distributed over a large cone or diffused. Antiglare or glare diffusing surfaces also provide some protection from finger prints and similar surface contamination that may cause readability problems. Glare diffusing surfaces reduce the intensity of the reflected light that reaches the viewer's eyes and is particularly effective in indoor applications where ambient light typically originates from several sources. On the other hand, under direct sunlight it may be relatively easy for a viewer to avoid the intense specular reflection from a single source while the somewhat less intense, but diffuse reflection from a glare diffusing surface may be sufficient to cause readability problems.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A display comprising:
(a) a transparent cover plate having a back surface and a front surface, a first polarizer supported by said cover plate; and
(b) a light valve including a second polarizer, said light valve arranged proximate to said cover plate defining a gap between said first and second polarizers and controlling an intensity of light transmitted through said touch panel.

2. The display of claim 1 wherein said front surface of said light valve comprises a glare diffusing surface.

3. The display of claim 1 wherein said rear surface of said cover plate comprises a glare diffusing surface.

4. The display of claim 1 wherein said display is free from including substantially birefringent material between the polarizing material of said first polarizer and the polarizing material of said second polarizer.

5. The display of claim 1 wherein said cover plate includes glass.

6. The display of claim 1 wherein said cover plate includes material therein that inhibits said cover plate from shattering.

7. The display of claim 1 wherein said display is free from including substantially birefringent material between the polarizing material of said first polarizer and said gap.

8. The display of claim 1 wherein said display is free from including substantially birefringent material between the polarizing material of said second polarizer and said gap.

9. The display of claim 1 wherein said gap is air.

10. The display of claim 1 wherein the polarizing material of said first polarizer is supported by a substantially non-birefringent material on a first side and a substantially birefringent material on a second side of said polarizing material.

11. The display of claim 1 wherein the polarizing material of said first polarizer is supported by a substantially non-birefringent material on a first side and a substantially non-birefringent material on a second side of said polarizing material.
